(19) United States
(12) Patent Application Publication
(10) Pub. No.: US 2005/0028755 A1
(43) Pub. Date: Feb. 10, 2005

(54) Waste collecting garment for dogs

(76) Inventor: Paul Le Fevre, Chateauguay (CA)

Correspondence Address: INVENTARIUM;SUITE 1607, 4050 ROSEMONT BLVD, MONTREAL, QC, H1X2M4, CA

(21) Appl. No.: 10/896,788

(22) Filed: Jul. 21, 2004

Related U.S. Application Data
(60) Provisional application No. 60/489,792, filed on Jul. 25, 2003.

(51) Int. Cl. A01K 23/00

(52) U.S. Cl. 119/868

(57) ABSTRACT

A waste collecting garment for dogs comprised of three distinct sections: A first for collecting feces and, in the case of females, urine as well, a second section to receive the first section and also collect urine in the case of males or place a sanitary napkin for females in heat, and a third section which acts as a garment for a dog, complete with pockets and also optionally equipped to collect urine in the case of males.

This application claims priority based on provisional application 60/489,792 filed Jul. 25, 2003

### BACKGROUND OF THE INVENTION

1. Field of the Invention

The invention relates generally to animal clothing in general but more particularly to a garment for dogs that also collects feces and urine.

2. Background of the Invention

City dwellers who own a dog have many things to worry about, none the least being to deal with the dog excrements issue. City by-laws regulate dog feces, forcing dog owners to collect the dung left behind by their pets. An alternative is to provide dogs with specially designed diapers that collect urine and/or feces.

The prior art does show a number of diapers and various harnesses designed to hold a sack which receives excrements. Some of those harnesses are quite complex and require skill and dexterity on the part of the dog owner in order to be properly fitted over the dog. Since many dog owners are elderly, blind or otherwise physically challenged, such complex harnesses could be beyond their abilities to install. Another drawback to the prior art is that it is also quite complex to dispose of the excrements afterward. There is therefore a need for an improved waste collecting garment for dogs.

### SUMMARY OF THE INVENTION

The present invention discloses a waste collecting garment for dogs comprised of three distinct sections: A first for collecting feces and, in the case of females, urine as well, a second section to receive the first section and also collect urine in the case of males or place a sanitary napkin for females in heat, and a third section which acts as a garment for a dog, complete with pockets and also optionally equipped to collect urine in the case of males. Since there is a multitude of dog varieties, it is possible that in the case of females of a small breed, the napkin be placed in the first section. The same goes for males of a small breed wherein urine could be collected in the first section as well. A variety of garments, suitable for different types of weather, can be fitted onto the same second section. Ordinary plastic bags such as grocery bags can be used to line the interior of the first section which receives excrements, there is therefore no needs for buying expensive disposable diapers or spending time cleaning. Such simplicity allows for the waste collecting garment for dogs to be used inside a dwelling as well as outside. Indeed, it can be even more distressing to have to pick up after your dog in your own dwelling as it is on a sidewalk. The invention is especially useful when training a new dog or after moving into a new place where the dog is nervous and unfamiliar as to where to relieve itself. Also, even though dog coats or garment have been known for years for some reason none of the prior art seems to have seen the combination of a coat with waste collecting, so it must not be so obvious to combine both.

The foregoing and other objects, features, and advantages of this invention will become more readily apparent from the following detailed description of a preferred embodiment with reference to the accompanying drawings, wherein the preferred embodiment of the invention is shown and described, by way of examples. As will be realized, the invention is capable of other and different embodiments, and its several details are capable of modifications in various obvious respects, all without departing from the invention. One such example is the absence of a connecting section for small sized dogs. Accordingly, the drawings and description are to be regarded as illustrative in nature, and not as restrictive.

### BRIEF DESCRIPTION OF THE PREFERRED EMBODIMENT

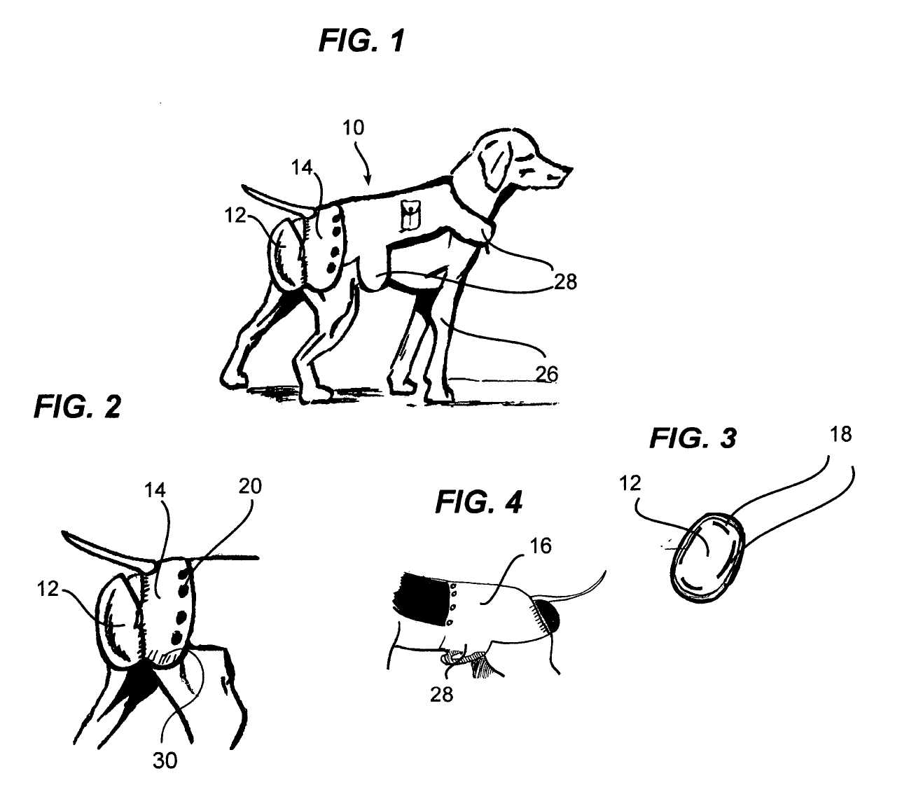

FIG. 1 is a perspective view of the waste collecting garment for dogs as worn by a dog with its three parts: the jacket, the connecting section, and the feces collecting section.

FIG. 2 is a perspective view detail focusing on the feces collecting section, the connecting section, the jacket, and shows the placement of a sanitary napkin.

FIG. 3 is a front view showing the interior of the feces collecting section.

FIG. 4 is a perspective view of the jacket part showing a urine collecting receptacle.

### DETAILED DESCRIPTION OF THE PREFERRED EMBODIMENT

A waste collecting garment for dogs (10) comprised of three distinct sections: A feces collecting section (12), a connecting section (14) and a jacket section (16). The feces collecting section (12) is attached to the connecting section (14) which provides for a secure attachment which is also very easily undone for the removal of the feces. It can be a zippered attachment as illustrated or any of a variety of known types of attachment means. Inside the feces collecting section (12) are adhesive bands (18) which help secure any suitable plastic bag used for receiving feces. The jacket section (16) can optionally receive pockets (22), which are releasably attached using hook and pile means (24), and is fitted onto a dog (26) using fastening means as is well known in the art.

The connecting section (14) which is illustrated here as having a button means of attachment can, as is the case of the feces collecting section (12), use any of a variety of attachment means, and it can also come with a urine collecting receptacle (28) designed for males or a napkin receptacle for females (30) but since dogs can be very small, it is possible that the collecting section (14) be removed for some species and that only the feces collecting section (12) and the jacket section (16) be attached together using attachment means discussed previously.

By having from two to three distinct parts, that is the feces collecting section (12) the connecting section (14), and the jacket section (16). For example, a dog owner can remove only the feces collecting section (12) without having to undo all the other sections. A last minute change in the jacket section (16) can be made without having to change the other sections. A fluorescent jacket section (16) could be used for walking a dog at night.

1. A waste collecting garment for dogs attached to a dog using fastening means well known in the art and comprising:
A feces collecting section, and a jacket section;
said feces collecting section being attached to said jacket section;
said feces collecting section designed to receive any suitable plastic bag.

2. A waste collecting garment for dogs as in claim 1 wherein:
a connecting section is used between said feces collecting section and said jacket section to accommodate larger dogs.

3. A waste collecting garment for dogs as in claim 1 wherein:
said jacket section having pockets releasably attached using hook and pile means.

4. A waste collecting garment for dogs as in claim 1 wherein:
said feces collecting section having adhesive bands to secure said suitable plastic bag.

5. A waste collecting garment for dogs as in claim 1 wherein:
said feces collecting section being attached to said connecting section by way of a zipper.

6. A waste collecting garment for dogs as in claim 2 wherein:
said jacket section having pockets releasably attached using hook and pile means.

7. A waste collecting garment for dogs as in claim 2 wherein:
said feces collecting section having adhesive bands to secure said suitable plastic bag.

8. A waste collecting garment for dogs as in claim 2 wherein:
said feces collecting section being attached to said connecting section by way of a zipper.
